(19) United States
(12) Patent Application Publication
(10) Pub. No.: US 2008/0035714 A1
(43) Pub. Date: Feb. 14, 2008

(54) Small Container Made From Thermoplastic Sheet Materials

(76) Inventor: Ole-Bendt Rasmussen, Walchwil (CH)

Correspondence Address: ROBERT W STROZIER, P.L.L.C, PO BOX 429, BELLAIRE, TX, 77402-0429, US

(21) Appl. No.: 11/792,449

(22) PCT Filed: Dec. 5, 2005
(86) PCT No.: PCT/EP05/13000

§ 371 Date: Sep. 6, 2007

(30) Foreign Application Priority Data
Dec. 7, 2004 (GB) 0426839.7

(51) Int. Cl. B65D 81/03; B32B 27/00; B32B 3/28

(52) U.S. Cl. 229/87.02

(57) ABSTRACT

A small container comprising as major components a generally rectangular frontside sheet A and a generally rectangular backside sheet B, both consisting of thermoplastic polymer material and each having an inner face and an outer face, wherein A and B are joined to each other at three edges (1,2,3) either directly or through connecting pieces of sheet material, while at least a part of a fourth edge (4A) and a corresponding part of an edge (4B) are not joined so as to serve as a mouthpiece characterised in that A and B are each a laminate consisting of at least two film layers wherein the film layer (5) which forms the inner face of the laminate has a corrugated waved shape with the waves extending generally parallel to an edge of the sheet, the other film layer(s) (6) are flat; and the direction (7) in which the waves in the film layer which forms the inner face of the sheet A extend is generally perpendicular to the direction (8) in which the waves in the film layer which forms the inner face of sheet B extend.

The invention concerns a small container, in particular an envelope, made from thermoplastic polymer material. Such envelopes are presently made from oriented material of high strength and have found widespread use especially for mailing of documents. The oriented sheets presently used are sheets made from highly oriented flash-spun fibres.

Important strength properties for this use are: tear initiation strength, tear propagation strength, puncture strength and yield tension, all considered in relation to the manufacturing cost and therefore not least to the gauge of the sheet. However, besides the strength of the properties, the stiffness against bending is also of high importance, and as well known the force needed to perform a certain small bending of a sheet varies with the 3^{rd} power of its thickness.

The main objective of the present invention is to enable a substantial reduction of the weight of envelopes (and other small containers of analogous construction) made from oriented thermoplastic material without sacrificing stiffness and strength properties. Other objectives will appear from the following.

WO-A-02/102592 describes and claims a laminated flexible but stiffened sheet consisting of a film of thermoplastic polymer material on one side which is corrugated with a wavelength generally about 3 mm or lower and on the other side another film of thermoplastic polymer material which film is not corrugated. (Each of these “films” may be an assembly of several thinner films). The corrugated and the non-corrugated films may both be oriented in uniaxial manner or may be biaxially oriented with one direction dominating, whereby such direction is preferably parallel with the direction in which the waves extend. The lamination is established through lower melting, co-extruded surface layers.

The sheet according to WO-A-02/102592 forms the basis of the present invention, although the wavelength of the corrugations in the present invention may be higher than the indicated about 3 mm. However, this sheet is not practically applicable in the known process for converting a sheet to envelopes (or to analogous products) since such processes always comprises a folding of the sheet in such manner that, if it were carried out on the above mentioned corrugated sheet, the corrugations on the frontside of the envelope would become parallel with the corrugations on its backside. This means that the envelope would become stiff against bending in one direction, but limp against bending in the direction perpendicular thereto, which is not acceptable.

WO-A-04/054793 discloses another stiffened but flexible corrugated sheet, differing from that disclosed in WO-A-02/102592 in that there are corrugations (flutes) on both sides of the sheet, whereby the direction of the corrugations on one side crosses the direction of the corrugations on the other side, preferably the two directions are perpendicular to each other. This gives highly improved stiffness in all directions, and with a wavelength down at about 1 mm the surface can receive a not too fine print and a handwriting with coarse letters, however the inherent coarseness of the print or handwriting is clearly a drawback for envelopes and analogous products.

The construction of the small container according to the present invention is described in claim 1. It is in particular directed to the construction of a high strength envelope. Briefcases, files and pouches are examples of other small containers which in many cases can advantageously be constructed according to the invention. In the invention the film layer which is non-waved is preferably essentially or substantially flat. Non-waved means that it has not been provided with the ward shape of the corrugated layer defined in the claim.

The wavelength of the waves (flutes) should preferably be no more than about 5 mm, preferably no more than 3 mm, and more preferably no more than about 1.5 mm. It is possible at least to bring the wavelength down to about 0.4 to 0.5 mm, but often above 0.7 mm.

The combination of a frontside with corrugations in one direction and a backside with corrugations in a direction generally perpendicular (a criss-crossing arrangement) to this gives the small container a surprising overall stiffness. It does, as already mentioned, require an entirely new conversion process with adhesive joining (e.g. heatsealing) of the frontside sheet A with the backside B along 3 edges of each sheet, either by direct bonding or bonding through connecting pieces of sheet material. A particularly practical way of carrying out this conversion is described later.

Mainly for strength purposes but also in order to facilitate the formation of the corrugations, at least one of the films which is supplied with corrugations is monoaxially oriented or is biaxially oriented with one direction dominating, and the direction of monoaxial orientation or dominating direction is mainly parallel with the direction in which the corrugations are extended. Furthermore, A and/or B are preferably cross-laminates. Thus the generally flat film in sheet A and/or in sheet B may have an orientation (or dominating direction of orientation) which is perpendicular to the direction in which the corrugations in the sheet extends, or the generally flat film may in itself be a cross-laminate.

When the envelope (or analogous product) according to the invention is made from a stiff polymer such as polypropylene or HDPE, it exhibits a high stiffness against bending in all directions and this is surprising, considering that the bonding between the crisscrossing corrugated films is established only at the edges of A & B. This stiffness is essentially higher than the stiffness of an envelope of similar size and weight made from flash-spun fibres. With adequate orientation and cross-lamination, the strength properties, in particular the tear propagation resistance, is also better. With a view to improved tear propagation resistance, the bonding of one film to another in cross-laminated sheet A and/or cross-laminated sheet B should preferably be a spot bonding.

In combination with the stiffening effect, a particular advantage of the mutually crisscrossing corrugations is a special cushioning effect. It helps to protect the contents of the envelope (or other container) and if the wavelength is short, i.e. about 1-2 mm or even when it is up to about 3 mm, it facilitates the writing or printing on the flat outside. This help to facilitate handwriting or printing by means of the structure in A and B and the crisscrossing relationship is a completely novel and surprising feature.

In order to enhance the cushioning effect, especially for protection of the contents, the channels formed between a corrugated film and the corresponding flat film in A and/or B may be closed at intervals by spot welding.

When protection of the contents by means of the cushioning effect is more important than facilitating handwriting or printing, the wavelength may with advantage be relatively long, e.g. generally about 5 mm or even longer than this.

Preferably, as detailed in claim 4, the generally non-waved film layer(s) of the sheets A and/or B, that is adjacent to the corrugated layer, is adhesively bonded in bonding zones to the crests on a first side of the corrugated waved shape film layer.

Corrugations along the machine direction can be produced by transverse stretching between intermeshing grooved rollers, and the lamination of a corrugated film to a flat film will also be carried out under use of a grooved roller. Hereby, it would be simplest to arrange the different rollers and the process parameters so that the crests of the corrugations become thinner than the basis on which they are bonded to the flat film. However, this does not produce a fully adequate stiffness and cushioning effect. On the contrary the basis is preferably made thinner than the crests, this by attenuation being carried out by stretching in the solid state. Very good stiffness and cushioning effects can also be achieved when the film thickness in the corrugated film is generally the same all over. This feature of the structure is more precisely expressed in claim 5, and the matter is described in more detail in the two PCT publications referred to above. Specific for the present invention is the stiffening and cushioning effects when the two sheets of laminates A and B are joined at their edges with their directions of names mutually crisscrossing.

In addition to such “first solid-state-attenuated zones” there may be a solid-state-attenuated zones on the crest of the corrugations, but narrower than the attenuated at the basis. These “second” zones serve to give the corrugations a mainly triangular cross-section, and thereby further to increase stiffness and cushioning effect. The “first” and “second” zones are illustrated in FIGS. 2 and 3 of WO-A-02/102592.

When at least one film from which A or B is made is an oriented film, it is of course essential not to ruin this orientation while the corrugated film is laminated with the non-laminated film. Therefore, like in the above mentioned WO-A-02/102592, the films are preferably co-extruded films with at least one lower melting layer, or the lamination is carried out as an extrusion lamination, in both cases with the aim to avoid overheating of the oriented film or sheet resulting in ruining the orientation.

Preferably the surface of the corrugated films which form the inner surfaces of the envelope (or the analogous small container) are also formed of co-extruded lower surface layers, whereby the conversion of the sheets A+B to the final article by heat sealing at the edges is facilitated.

In many cases, especially when the small container is an envelope, the mouthpart of the front side sheet A should preferably be extended beyond the back side B to form a flap closure. Then the direction in which the corrugations in A extend should preferably be parallel with the corresponding edge of the backside sheet B, whereby the folding of the flap is facilitated.

When the present invention is used to make envelopes (but also for several other types of small containers) the outside of the container is preferably treated to receive water based ink. This treatment is applied to the entire non-waved film part of A and/or B or only the co-extruded layer. This layer or the entire film is first made microporous in a well-known manner by blending the thermoplastic material (before the extrusion) with a suitable powder, such as talc powder, which upon stretching of the extruded, solidified film produces micro-voiding, and subsequently the voided film surface is treated e.g. with a corona treatment.

In order to enhance the aesthetics of the product, the non-waved film may be supplied with a suitable pattern of fine embossment, for instance suitable pattern of fine embossment, for instance suitable to give it the look of a textile. Such embossment is not wave-form, however. It is preferably an over-all pattern.

It has already been mentioned that polypropylene and HDPE are particularly suitable as raw materials for the container, e.g. envelope, according to the invention. Other suitable materials are: polyethylene in general, e.g. LLDPE, or blends of LLDPE and HDPE, blends of PP and LLDPE, polyamides and polyethylene terephthalate.

In order to achieve particular high strength values, the extrusion/stretching methods disclosed in WO-A-04/094129 can be applied.

The conversion of sheets A and B to a small container should preferably be a continuous process in which both sheets are fed continuously into the apparatus which performs bonding of the edges. Therefore, one sheet should have its corrugations extending in the machine direction (m.d.) while in the other sheet the corrugations extending in the transverse direction (t.d.). WO 02/102592 discloses methods for making both types of corrugated laminates. Furthermore, improved methods of making a t.d. corrugated laminate is disclosed in WO-A-04/054793, specifically in claims 67-73 and related description.

The conversion of the A and B sheets to envelopes or analogous small containers is preferably carried out continuously, starting with wide sheets of A and B. Sealing and cutting can take place during continuous, smooth movement of the sheets. Sealing involves the application of both heat and pressure. In this case the longitudinal sealing can be band sealing, and the transverse sealing can be impulse sealing between bars which are carried by moving chains. Alternatively the sealing and cutting can be carried out intermittently, the sealing taking place between steady impulse sealers. It is essential to cool the seal before the sealing pressure becomes released, since shrinkage of one or both sheets otherwise may distort the shape of the container (make it curl or bend). The sealing is such that in the main body of the seal, the corrugations are flattened whereas at the very edges of sealing, the corrugations are still intact and a discontinuous seal is achieved. This is important from the view point of a surprisingly high shock-sealing strength and in one embodiment, can be achieved using a tapered sealing bar. One example of suitable apparatus is a combination of a heated sealing bar pressing against a rubber plate. As mentioned above, these sealing processes should preferably be enhanced by means of a extruded lower melting surface layer, whereby a relatively low sealing temperature can be used.

The simplest way to form a flap closure at the mouthpart of sheet A, extending beyond the edge of the mouthpart of sheet B, is to cut away a corresponding portion of sheet B and recycle this portion in the extrusion.

In the described conversion process, the flap can also be supplied with a band constructed for self-adhesive closure or for zip-closure.

The container (envelope) can be supplied with side- or bottom-gussets, e.g. in the abovementioned continuously or interruptedly moving conversion process. These are made from separate, folded bands which are introduced between sheet A and sheet B into bands which have the width wanted for the container. Subsequently the folded bands are sealed to the edge portions of A and B.

The invention shall now be explained in further detail with reference to the figures.

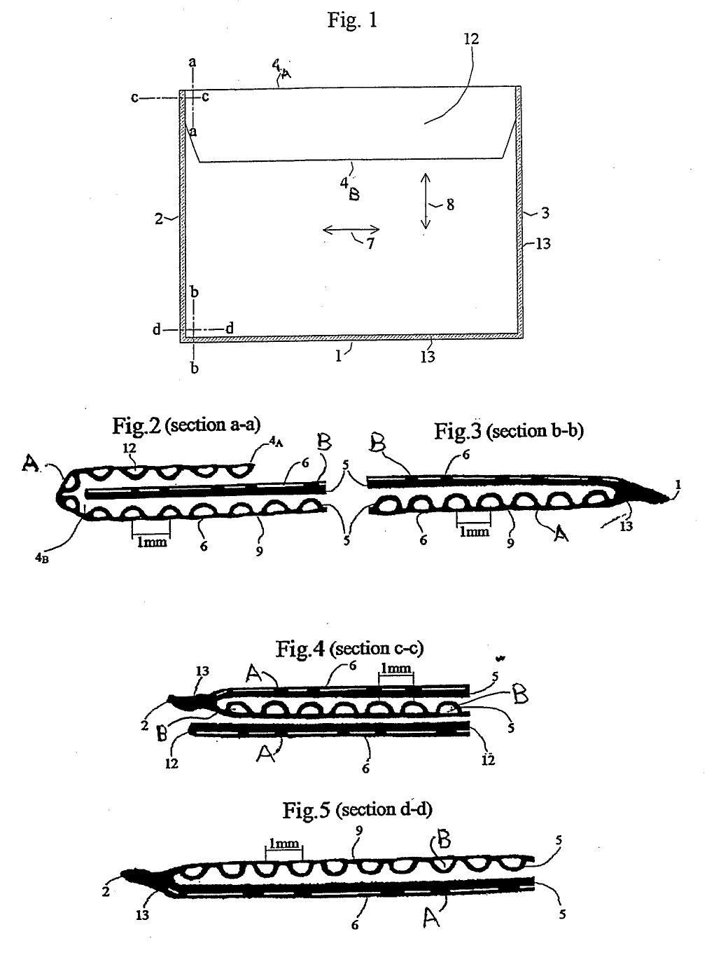

FIG. 1 is a sketch viewed from the backside an envelope according to the invention, and

FIGS. 2-5 are magnified photos made from a laboratory manufactured envelope and showing the different sections which are indicated on FIG. 1, namely:

FIG. 2 shows section a-a;

FIG. 3 shows section b-b;

FIG. 4 shows section c-c, and

FIG. 5 shows section d-d.

On these magnified photographs white interrupted lines are drawn to indicate in principle, the border between flat films and corrugated films, which the photograph itself could not distinguish.

Sealing was carried out by use of laboratory sealing apparatus comprising a sealer bar heated to a temperature of approximately 150° C. pressing against a rubber plate. Sheets A and B were tensioned in the direction of the seal, in order to avoid shrinkage in this direction during sealing and a subsequent cooling. In order to seal the two sheets together, a pressure of approximately 20 kPa was applied to the edges to be sealed. Following sealing, the joined sheets were cooled using a wet pad while still in contact with the rubber plate. The sealer bar is tapered which means that at the very edges of the seal, the seal is discontinuous and remains corrugated while the pressure is such that in the main body of the seal, the corrugations are flattened and a continuous seal is achieved.

The envelope consists of the two sheets A and B, each comprising a corrugated film (5) and a non-waved, in this case generally flat film (6).

The edge (4A) of the front side sheet A extends beyond the edge (4B) of B to form a flap closure (12). Along the other edges (1,2 and 3) the two sheets are joined by heat-seals (13). The direction (7) in which the corrugations in sheet A extend is parallel with edges (4A) and (4B), while the direction in which the corrugations in sheet B extend is perpendicular to this.

The envelope from which these photos were taken were hand-made from corrugated sheet material, produced continuously by laboratory machinery, which is constructed almost exactly as shown in FIGS. 4 and 5 of WO-A-02/102592. Both the corrugated film (5) and the generally flat film (6) consist of one coextruded, cold-stretched 0.037 mm thick film consisting of HDPE with a thin layer on one side, consisting of an ethylene copolymer having a melting range between 95-105° C. As indicated on present FIGS. 2-5, the wavelength was 1.0 mm.

With reference to FIGS. 2 and 4, in practice a suitable tape for closure ought to be fixed on the corrugated side of flap (12) or on the corresponding flat side of sheet B, but this is not shown.

1. An envelope comprising as major components a substantially rectangular frontside sheet A and a substantially rectangular backside sheet B, both comprising a thermoplastic polymer material and each having an inner face and an outer face, wherein the frontside sheet A and the backside sheet B are joined to each other at three edges (1,2,3) either directly or through connecting pieces of sheet material, while at least a part of a fourth edge (4A) and a corresponding part of an edge (4B) are not joined so as to serve as a mouthpiece, each of the frontside sheet A and the backside sheet B comprises a cross-laminate comprising at least two film layers wherein the film layer (5) which forms the inner face of the laminate has a corrugated waved shape with the waves extending substantially parallel to an edge of the sheet and having a wavelength no more than 5 mm, the other film layer(s) (6) are non-waved and the flat film in the frontside sheet A and/or in the backside sheet B has an orientation which is perpendicular to the direction in which the waves in the sheet extend or is a cross-laminate; and the non-waved film layer(s) (6) of the frontside sheet A and/or the backside B which is adjacent to corrugated waved shape film is adhesively bonded in bonding zones to the crests on a first side of the corrugated waved shape film layer and the direction (7) in which the waves in the film layer which forms the inner face of the frontside sheet A extend is substantially perpendicular to the direction (8) in which the waves in the film layer which forms the inner face of the backside sheet B extend, where the adhesive bonding comprises heat sealing and where at least one of the films which has a corrugated waved shape is monoaxially oriented in a direction or biaxially oriented with one direction dominating, whereby such direction is substantially parallel with the direction in which the waves extend, and where either the thickness of each of the corrugated waved shape layer of the frontside sheet A and/or the backside sheet B is substantially the same in bonded and unbonded zones, or the film comprises first solid-state-attenuated zones (9) extending parallel to the extension of the waves, each bonding zone substantially being located within such a first attenuated zone whereby each first attenuated zone is understood as delimited by the positions where the thickness is an average between the lowest thickness of this film within the first attenuated zone and the widest thickness of the film is within the adjacent non-bonded zone.

2. (canceled)

3. The envelope according to claim 1, wherein the wavelength of the waves is no more than 3 mm.

4. (canceled)

5. (canceled)

6. The envelope according to claim 1, wherein the film further comprises a second solid-state-attenuated zone between each pair or adjacent first attenuated zones, said second attenuated zones being narrower than said first attenuated zones and located on the non-bonded crests of the respective waved film.

7. (canceled)

8. (canceled)

9. The envelope according claim 1, wherein the frontside sheet A and the backside sheet B comprise polypropylene, polyethylene, polyamide or polyethylene terephthalate.

10. The envelope according claim 1, wherein the frontside sheet A and/or the backside sheet B at least in an outermost surface part of the envelope is made microporous and in this part is treated for acceptance of a water based ink.

11. The envelope according to claim 1, wherein the joining of the sheets A and B with each other directly or through connecting pieces of sheet material has been established via heat sealing.

12. The envelope according claim 1, wherein channels formed between a corrugated film (5) and the corresponding non-waved film (6) in the frontside sheet A and/or the backside sheet B are closed at intervals by spot welding.

13. The envelope according the mouth piece of the frontside sheet A extends beyond the backside sheet B to form a flap closure (12).

14. The envelope according claim 1, wherein the non-waved film (6) in the frontside sheet A and/or the backside sheet B is provided with a pattern of fine embossment.

15. The envelope according to claim 1, wherein the heat-sealing is achieved by means of a lower-melting layer on the film provided by coextension.

16. The envelope according to claim 1, wherein the heat-sealing is achieved by means of a lower-melting layer on the film provided by extension lamination.

17. The envelope according to claim 15, wherein the surfaces of the corrugated films which form the inner surfaces of the envelope are also formed of co-extruded lower surface layers.

18. The envelope according to claim 16, wherein the surfaces of the corrugated films which form the inner surfaces of the envelope are also formed of co-extruded lower surface layers.

19. The envelope according to claim 1, wherein the wavelength of the waves is no more than 1.5 mm.
